(19) United States
(12) Patent Application Publication
(10) Pub. No.: US 2013/0091513 A1
(43) Pub. Date: Apr. 11, 2013

(54) SEAMLESS EXTERNAL PROCESS INTEGRATION

(71) Applicants: Olav Underdal, San Diego, CA (US); Craig Schneider, San Diego, CA (US); Frank Williamson, San Diego, CA (US); Srdan Mihajlovic, San Diego, CA (US); Voltaire Garcia, San Diego, CA (US); Anthony Rensfield, San Diego, CA (US); Richard Roberts, San Diego, CA (US)

(72) Inventors: Olav Underdal, San Diego, CA (US); Craig Schneider, San Diego, CA (US); Frank Williamson, San Diego, CA (US); Srdan Mihajlovic, San Diego, CA (US); Voltaire Garcia, San Diego, CA (US); Anthony Rensfield, San Diego, CA (US); Richard Roberts, San Diego, CA (US)

(73) Assignee: Mitchell International, Inc., San Diego, CA (US)

(21) Appl. No.: 13/270,187

(22) Filed: Oct. 10, 2011

(51) Int. Cl. G06F 9/46

(52) U.S. Cl. 719/328

(57) ABSTRACT

A parent computer application interacts with one or more independently operating embedded child applications so as to provide an integrated seamless operating environment in which the embedded child applications are presented through the user interface of the parent application and may be controlled through the parent application. A computer operating system provides a user interface such that each installed computer application is allocated its own respective memory space by the operating system, and includes a library that is utilized for its operation, only one of the computer applications as an active application at any time. The system detects when one of the embedded child applications is the active application of the operating system, and in response changes a parent application attribute to ensure that a single integrated application window is displayed.

### BACKGROUND

When using computer systems, it is sometimes beneficial to execute multiple computer applications in cooperation with each other. For example, one application may be suitable for performing a specialized function that cannot be performed by a second application, which in turn performs a function that cannot be performed by the first application, but which utilizes output produced by the first application. In other situations, data generated as output by one application may be needed immediately thereafter as input for another program, so that both applications must be executed in sequence or perhaps simultaneously. Situations where it is desired to operate multiple independent applications together may arise, for example, where a company owns legacy computer applications that are to be used in cooperation with new applications that were obtained through purchase or by virtue of acquisition or merger with another company.

In a conventional computer operating system with windowing features, multiple computer applications may be launched to independently execute at the same time, in respective application windows of the operating system. With a different window for each application, a user may take action by moving from application window to application window in the operating system, and by performing necessary functions in the respective application windows. Such operation, however, can be cumbersome and inefficient. In that scenario, each application must be identified and launched by the user. Different applications may utilize different data input and output schemes, and may use different menus with different user interfaces. This is not convenient for the user, who must jump from application window to application window, and is far from the seamless user experience that is desired for applications within a window operating system.

Some applications that are produced by a single vendor may comprise a suite of applications with a user interface that is common across the applications in the suite. For example, the “Office 2010” and “Office 2007” application suites from Microsoft Corporation of Redmond, Wash., USA provide applications for word processing, spreadsheet, presentation functions, and the like so as to provide a common user interface among the applications in each suite. These suites of applications utilize the “Object Linking and Embedding” (OLE) scheme of the “Microsoft Windows” operating system that permits a user to add different kinds of data to a document from different applications. For example, a user may execute a text editor application to import a graphic image from an image editor application. This creates a compound document. Unfortunately, in such suites, the degree of integration is generally dependent on the wishes of the suite vendor, not the user, and the application integration is not available for applications outside of the suite. The applications in the “Office 2010” and “Office 2007” suites, for example, generally utilize shared libraries referred to as dynamic linked libraries (DLL), or the “.NET framework” for more recent “Windows” operating systems, through which multiple applications share a common set of library files for operation of applications. Similar integration between application programs of a suite from a single vendor are provided by, for example, the “Creative Suite” applications that are available from Adobe Systems Incorporated of San Jose, Calif., USA.

Other techniques for providing cooperative execution of multiple programs and obtaining the benefits of the respective functions involve creating a single replacement application that incorporates the functions and features of all the previously independent computer applications. Incorporating features and functions from multiple independent applications into a single application can be quite complicated and can require generating many lines of source code. Such program creation efforts require significant resources and can require a great deal of time to complete. Moreover, such efforts must be duplicated each time an application is to be included in the integrated combination, or deleted from the combination.

It would be advantageous if users could independently select computer applications for cooperative execution to provide the user with a seamless operational experience without the need for producing significant programming efforts. This type of cooperative operation among multiple independent computer applications can provide a seamless integration of the applications that otherwise operate as independent processes that are external to each other.

### SUMMARY

A parent computer application interacts with one or more independently operating embedded child applications so as to provide an integrated seamless operating environment in which the embedded child applications are presented through the user interface of the parent application and may be controlled through the parent application. As disclosed herein, a computer operating system provides a user interface presented on a display of a computer system in which a plurality of computer applications are installed such that each computer application is operable as a program hosted by the operating system and is allocated its own respective memory space by the operating system, and includes a library that is utilized for its operation, and such that the operating system designates only one of the computer applications as an active application at any time. One of the installed computer applications comprises a parent application and one or more of the remaining installed computer applications comprise embedded child applications of the parent application such that the parent application designates itself as the parent application to all the embedded child applications, and the parent application detects when one of the embedded child applications is not running and, in response, launches the not running embedded child application for operation, and wherein the parent application changes display attributes in the operating system of itself and the embedded child applications to ensure that the parent application and the embedded child applications are displayed as a single integrated application. In this way, multiple independently operable embedded child applications can be viewed through, and controlled by, the user interface of the parent application.

In one embodiment, the parent application detects when one of the embedded child applications is the active application of the operating system, and in response changes a parent application attribute to ensure that the parent application and the embedded child applications are displayed as a single integrated application, such that the parent application attribute that is changed comprises denoting that the parent application is parent to all child windows of the embedded child applications. Thus, a child window of a child application is understood by the operating system to be a child window of the parent application.

In another aspect, the parent application determines when any one of the embedded child applications is the active application of the operating system and, in response, the parent application changes an attribute in the operating system to indicate in the operating system that the parent application is to be illuminated. In this way, the parent application remains illuminated so as to appear to be the active application, even when one of the embedded child applications is the active application of the operating system.

In another aspect, the parent application receives event notifications from the embedded child applications through a unidirectional communication channel, wherein the parent application is notified of events in the respective embedded child applications. In another aspect, the parent application provides commands to the embedded child applications through a bidirectional communication channel.

Other features and advantages of the present invention will be apparent from the following description of the embodiments, which illustrate, by way of example, the principles of the invention.

### BRIEF DESCRIPTION OF THE DRAWINGS

FIG. 1 is a block diagram that shows information flow between a parent application, operating system, and an embedded child application as described herein.

FIG. 2 shows a display screen of a computer that is installed with a parent application and embedded child applications as described herein.

FIG. 3 is a block diagram that shows information flow between the parent application, operating system, and an embedded child application with unidirectional and bidirectional communication channels.

FIG. 4 is a flow diagram that illustrates operation of a computer system as described herein.

FIG. 5 shows a display screen of a computer that is installed with a parent application and embedded child applications as described herein for a parent application that provides shop management features and is called “Mitchell RepairCenter”.

FIG. 6 shows a System Configuration “Value Added Options” pop-up window of the child application illustrated in FIG. 5 under an “About” sub-tab of an “Estimating” tab.

FIG. 7 shows menu options available under the Estimating tab illustrated in FIG. 6.

FIG. 8 shows a System Profiles pop-up window of the child application that is shown in the parent application illustrated in FIG. 5, under the “Estimating” tab.

FIG. 9 shows an “Estimate Rates” embedded view of a pop-up window from the child application that is shown in the parent application illustrated in FIG. 5, under the “Estimating” tab.

FIG. 10 shows a “Preferences” embedded view of a pop-up window from the child application that is shown in the parent application illustrated in FIG. 5, under the “Estimating” tab.

FIG. 11 shows a “Standard Long Expansion” embedded view of a pop-up window from the child application that is shown in the parent application illustrated in FIG. 5, under the “Estimating” tab.

FIG. 12 shows a “Labor/Tax Rates” window of the child application that is shown in the parent application illustrated in FIG. 5, under the “Estimate” tab.

FIG. 13 shows a “Part Detail” pop-up window of the child application that is shown in the parent application illustrated in FIG. 5, under the “Estimate” tab.

FIG. 14 shows a display screen of the installed application called “Mitchell Estimating” as provided by the operating system when operated independently of the parent application called “Mitchell RepairCenter” as illustrated in FIG. 5.

FIG. 15 shows a “System Configuration” pop-up window of the “Mitchell Estimating” installed application illustrated in FIG. 14 corresponding to the “System Configuration” pop-up window illustrated in FIG. 6 of the parent application.

FIG. 16 shows an “Estimate Rates” pop-up window of the “Mitchell Estimating” application when operated independently of the parent application, corresponding to the embedded child application illustrated in FIG. 9.

FIG. 17 shows a “Preferences” pop-up window of the “Mitchell Estimating” application when operated independently of the parent application, corresponding to the embedded child application illustrated in FIG. 10.

FIG. 18 shows a “Standard Long Expansion” pop-up window of the “Mitchell Estimating” application when operated independently of the parent application, corresponding to the embedded child application illustrated in FIG. 11.

FIG. 19 shows a “Labor/Tax Rates” pop-up window of the “Mitchell Estimating” application when operated independently of the parent application, corresponding to the embedded child application illustrated in FIG. 12.

FIG. 20 shows a “Part Detail” pop-up window of the “Mitchell Estimating” application when operated independently of the parent application, corresponding to the embedded child application illustrated in FIG. 13.

FIG. 21 shows a configuration for a computer system constructed in accordance with the present disclosure.

### DETAILED DESCRIPTION

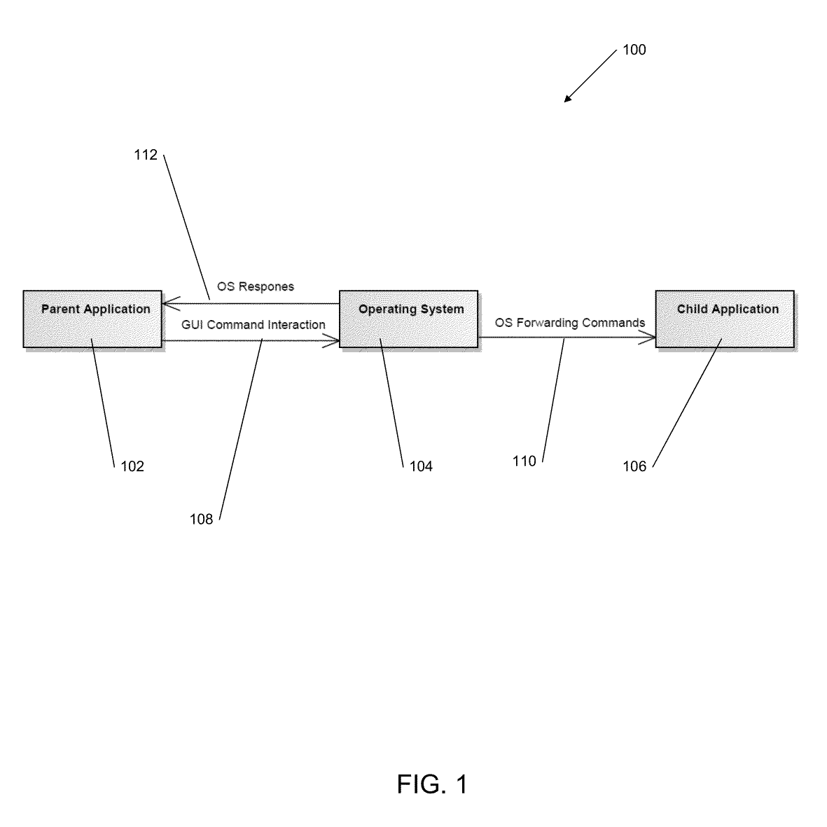

FIG. 1 is a block diagram that shows information flow between a parent application 102, operating system 104, and an embedded child application 106 as described herein. The operating system executes on a computer system to provide an operating environment that supports the execution of application programs that may be controlled through a graphical user interface (GUI) that is presented on a display of the computer system. As described further below, the computer system may comprise a conventional general purpose system such as a “Personal Computer” (PC), desktop computer, laptop computer, tablet computer, or the like. A plurality of computer applications are installed in the computer system such that each computer application is operable as a program hosted by the operating system and is allocated its own respective memory space by the operating system, and includes a library that is utilized for its operation.

The operating system may provide a GUI environment, such as a windowing environment, and designates only one of the installed computer application programs as an active application at any time. The installed applications are independently operable, in accordance with their separate memory space and program libraries. Those skilled in the art will understand that the active application of an operating system is the application program for which the processor of the computer system is actively performing operations and with which the user may currently interact.

A windowing operating system as depicted in FIG. 1 may comprise, for example, the “Windows 7” operating system available from Microsoft Corporation of Redmond, Washington, USA, or other similar GUI operating systems, such as “Linux” (available in various distributions from various sources) and “Mac OS X” (available from Apple, Inc. of Cupertino, Calif., USA). It will be understood that each window of an application in a windowing system is identified with a “handle” that is associated with the application and that designates the window as “active” or “inactive”, and also designates the parent application. As additional windows of the application are opened, they generally are displayed in the foreground of the windowing environment, so that the “youngest” child window is the most forward window in the windowing environment, and comprises the active window of the application. In the computer system described herein, an installed application referred to as the parent application is fixed as the parent application of all the applications that are associated with it, applications that are referred to as embedded child application.

The parent-child relationship of the application windows is important to the operating system for determining details of how each window will be displayed. For example, in a windowing operating system, a parent window generally determines display attributes of child windows that are opened and that are based on the parent application. A parent window of an application is generally the window to which event notifications from child windows of the application are directed by the operating system. In the illustrated system of FIG. 1, however, the parent application 102 is fixed with the operating system 104 so as to be the parent application for all the installed applications 106 that are embedded within it. That is, these embedded child applications 106 are identified to the operating system as child applications of the designated parent application.

In accordance with the embedded child applications described herein, the computer system hosts multiple installed computer applications, wherein one of the installed computer applications comprises a parent application, and one or more of the remaining installed computer applications comprise embedded child applications of the parent application such that the parent application designates itself as the parent application to all the embedded child applications. In addition, the parent application detects when one of the embedded child applications is not running and, in response, launches the not running embedded child application for operation. The parent application also changes display attributes in the operating system of itself and the embedded child applications to ensure that the parent application and the embedded child applications are displayed as a single integrated application.

More particularly, a parent application as used herein refers to an installed computer application that acts as a host for one or more additional installed computer applications that comprise embedded child applications, which are displayed and controlled in the operating system such that the parent application and embedded child applications provide a seamless programming experience and interface for a user of the computer system. In accordance with the integrated, seamless operation, the user can control the parent application and child applications through the interface of the parent application without leaving the operation of one application to take up the operation of the next. That is, the parent application and additional embedded child applications are controlled by the user as if they were a single, integrated application rather than comprising two independently operating applications. Nevertheless, the embedded child applications are still capable of being independently operated within the operating system, outside of the parent application.

The parent application achieves the features described herein through execution during operation that re-parents the child applications and the child application windows to the parent application. That is, the parent application, when executed, will detect when one of the embedded child applications is not running and, in response, will launch the not-running embedded child application for operation. The parent application will communicate with the operating system so that windows of the child applications will be child windows of the parent application, rather than child windows of their respective embedded child applications. The parent application achieves this by mapping the commands, such as menu items, of each of the embedded child applications to corresponding menu items of the parent application. The possible commands and menus and windows of the child applications may be determined even without analysis of source code through many different techniques, which will be known to those skilled in the art. In this way, when a user wants to control an embedded child application, the user simply selects an appropriate child application command from the menu of the parent application. The parent application provides the selected command to the operating system, with information that will direct the selected command from the operating system to the appropriate embedded child application. In this way, the embedded child application will take the action desired by the user through execution of the selected command, as provided through the parent application.

For example, an embedded child application may be launched by the parent application in a .NET framework by using program code in the parent application such as the following code listed in Table 1:

TABLE 1
class MyProcess
{

public static void Main( )
{

Process myProcess = new Process( );
try
{

myProcess.StartInfo.FileName = “C:\\MyApplication.exe”;
myProcess.Start( );

}
catch (Exception e)
{

Console.WriteLine(e.Message);

}

}

}

A “MyProcess” call would be executed by the parent application for each installed application to be an embedded child application. Those skilled in the art will be able to produce code suitable for other operating systems, in view of the exemplary code of Table 1.

In operation, when the parent application is launched, it checks to determine if all its embedded child applications are running For each embedded child application that is not already executing, the parent application will launch the child application and will re-parent that application as noted. For each embedded child application that is already executing, the parent application will re-parent that application as noted. Thus, the embedded child applications can be launched and executed independently of the parent application (that is, they may be used independently of the parent application), but the parent application will, upon launch, assume control over any executing child applications and will launch any non-running child application.

FIG. 1 depicts the information flow between the parent application 102, operating system 104, and embedded child application 106. In FIG. 1, a user first selects a command through the parent application 102, comprising a GUI command, and the parent application provides the command to the operating system 104. Communication of the selected command occurs through a conventional command communication channel 108 between the parent application and operating system. In FIG. 1, this channel 108 is labeled “GUI Command Interaction”. The operating system 104 receives the command, with the information to designate the intended embedded child application, and provides the command to the appropriate embedded child application through a conventional command communication channel 110 (“OS Forwarding Commands” in FIG. 1) between the operating system and the child application 106. Responses, such as notifications, system messages, and the like, are provided from the operating system 104 back to the parent application 102 via a conventional response communication channel 112 (“OS Responses” in FIG. 1).

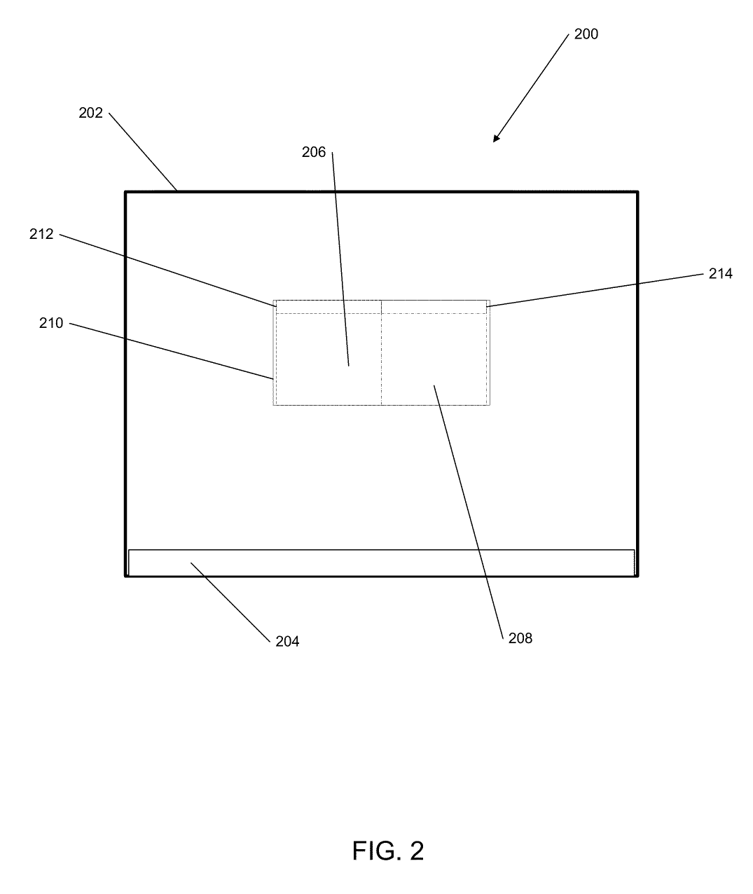

FIG. 2 depicts a computer system 200 provided with the parent application and embedded child application described herein. FIG. 2 shows a display screen 202 of the computer system with an operating system that provides a windowing system with graphical user interface (GUI). A taskbar or dock 204 is illustrated along the lower edge of the display created by the operating system, as will be known to those skilled in the art. Two embedded child applications 206, 208 are displayed in the middle area of the window display screen 202, indicated by dashed lines for clarity of illustration. A parent application 210 is indicated by a solid line boundary around the two embedded child applications. If desired, the parent application may have an inconspicuous or even absent border that will not be displayed during operation. Whether or not the parent application is visible by means of the depicted border 210, however, the parent application provides a seamless operation and manipulation of the two embedded child applications, in that selecting one child application or the other 206, 208 with a display mouse click, and resizing or repositioning the parent application 210, will resize or move both of the child application windows 206, 208 in unison. This unified behavior is obtained because of the mapping and communication between the parent application, operating system, and embedded child applications as depicted in FIG. 1 and described above.

The parent application may also implement other desired changes in the way in which the embedded child applications are displayed and modified. For example, the task bar 204 in FIG. 2 does not display program icons for the embedded child applications, even though the applications are, in fact, executing and would normally produce corresponding program icons in the task bar. Instead, the parent application suppresses the program icons, because not displaying the icons contributes to providing a seamless programming experience for the user, in that all user modifications and changes to operation of the embedded child applications can be carried out through modification and change commands entered from the parent application.

The parent application also processes display modification commands from the user to ensure a seamless, integrated experience in utilizing the embedded child applications through the parent application. As noted above, repositioning and resizing the parent application window 210 will automatically reposition and resize the corresponding embedded child application windows 206, 208. In addition, during operation, modality of the child applications is appropriately controlled. For example, if an embedded child application is displaying a modal dialog box, then the parent application needs to be disabled from receiving modifications or commands so the user can attend to the dialog box. That is, the application behaves modally to ensure a response to the dialog box is received from the user before continuing with operation.

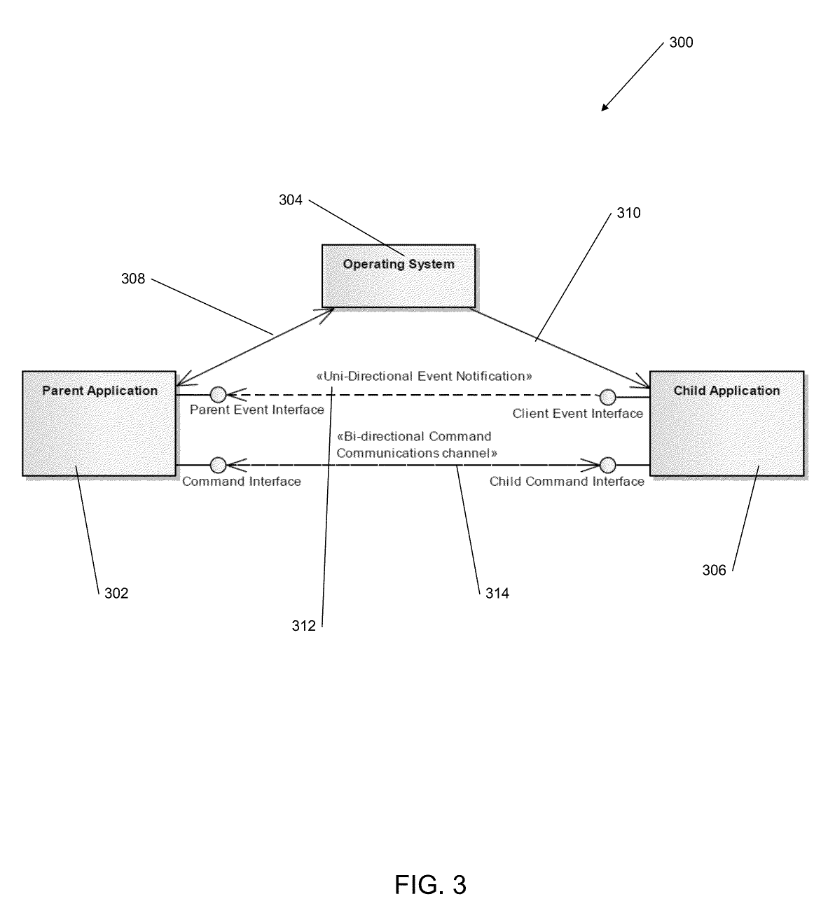

FIG. 3 is a block diagram that shows information flow in a computer system 300 between the parent application, operating system, and an embedded child application with unidirectional and bidirectional communication channels. FIG. 3 depicts a more complicated embedding and interacting scenario as compared with the scenario depicted in FIG. 1. FIG. 3 includes the scenario of FIG. 1, in that FIG. 3 shows information flow between a parent application 302, operating system 304, and embedded child application 306. As before, a user may select a command through the parent application 302 and the parent application provides the selected command to the operating system 304, whereupon communication of the selected command occurs through a conventional command communication channel 308 between the parent application and operating system. The operating system 304 receives the command, with the information to designate the intended embedded child application, and provides the command to the appropriate embedded child application 306 through a conventional command communication channel 310 between the operating system and the child application. The scenario of FIG. 3, however, provides additional channels of communication.

FIG. 3 shows a unidirectional communication channel 312 between the parent application 302 and the embedded child application 306. The child application notifies the parent application of child application events through the unidirectional event notification communication channel 312. The FIG. 3 scenario also includes a bidirectional communication channel 314 between the parent application and the embedded child application over which the parent application communicates commands directly to the embedded child application.

For each of the communication channels 312, 314, the communications from either the parent application 302 or the child application 306 are carried by the operating system between the interface points illustrated in FIG. 3. That is, if a child application wishes to send information to the parent application over the unidirectional channel 312, it does so by sending the information to the client event interface, which is received by the operating system and which contains sufficient information for the operating system to properly direct the information to the event interface of the parent application, which then receives the information. The operating system does not examine the information or associated message for content, but merely acts as a conduit for the information. Similarly, if the parent application 302 and child application 306 want to share information such as commands over the bidirectional communication channel 314, they provide information at their respective command interfaces, with sufficient information to indicate to the operating system where the information should be directed, and the operating system then transports the information to the proper intended recipient.

An example of the processing for handling messaging between the parent application and an embedded child application for events, notifications, and the like is provided in the pseudo code listed below in Table 2:

TABLE 2

Server:
Server.EventNotificationFire
ServerInterface.CreateEventMessage
ServerInterface.SendMessageToCLient
Client:
DoListenOnThread

ClientInterface.ReadMessageFromServer
ClientInterface.ProcessesMessage
ClientInterface.GenerateEvent

Until ShutDown
Client.HandleEvent

In the pseudo code of Table 2, the “Server” corresponds to the application providing communication of a notification or command or other communication, and the “Client” corresponds to the application receiving the communication. For example, in the case of a communication from the parent application to the embedded child application, such as illustrated in FIG. 1, the “Server” corresponds to the parent application, and the “Client” corresponds to one of the embedded child applications. In the case of the FIG. 3 unidirectional communication illustrated in the path 312 from child application to parent application, the “Server” in the pseudo code of Table 2 corresponds to the child application, and the “Client” corresponds to the parent application. Those skilled in the art will understand how to implement the pseudo code of Table 2 in a corresponding operating system to obtain the described features, in view of the description and drawings herein.

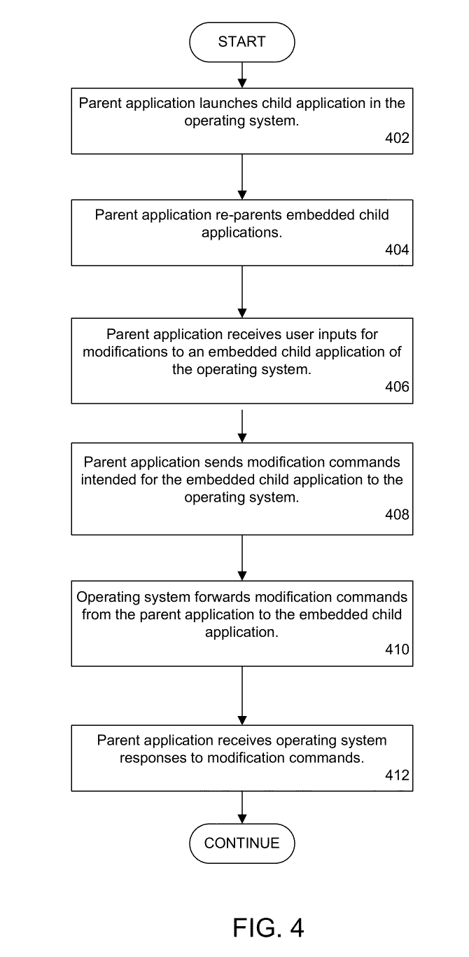

FIG. 4 is a flow diagram that illustrates operation of a computer system as described above and depicted in FIGS. 1-3. In the first operation, represented by the flow diagram box numbered 402, the parent application launches the embedded child application in the operating system. The number of embedded child applications launched by the parent application depends on the number of applications installed in the operating system that are also embedded child applications. That is, the number of installed applications that are embedded and integrated with the parent application will be specified by the mapping within the parent application. The parent application includes, within its executable instructions or in its operational data, information that specifies the installed applications that are embedded and that specifies the menu items of the parent application and corresponding menu items of the child application. That is, the mapping between the parent application and an installed application defines that installed application as an embedded child application of the parent application, such that the embedded child application may be controlled through user interaction with the parent application. It should be noted that the embedded child application may still be launched and operated independently of the parent application, if a user should so desire. Thus, any dynamic linked libraries or other operational artifacts of the child application remain intact as part of the installation of child application independent of the parent application.

In the next operation, represented by the flow diagram box numbered 404, the parent application re-parents the embedded child applications. When the parent application is launched by a user, the executable instructions of the parent application cause the installed applications that were launched by the parent application in 402 to be re-parented to the parent application. That is, any child windows that are generated by the respective child applications will be registered with the operating system as child windows of the parent application, not as child windows of the child application.

The next operation, represented by the flow diagram box 406, comprises the user interacting with the parent application, such that the parent application receives user inputs for modifications to an embedded child application of the operating system. For example, in the case of the simple scenario depicted in FIG. 1, the user inputs for modifications comprise resizing and repositioning inputs. For the more complicated scenario depicted in FIG. 3, the modifications comprise commands or data entry generated by the user as the user interacts with the parent application, such that the commands are intended for an embedded child application and comprise modifications to the child application. That is, the commands and data entry under FIG. 3 may result in modifications to operation of the intended embedded child application, as depicted in box 406 of FIG. 4.

In the next operation, represented by the flow diagram box 408 in FIG. 4, the parent application sends the modifications intended for the embedded child application to the operating system. This action corresponds to the communication 108 illustrated in FIG. 1, or the communication 308 illustrated in FIG. 3, or communication 314 in FIG. 3. The operating system, at box 410, then forwards the modification commands from the parent application to the embedded child application, which then implements the modification command. This operation corresponds to the communication 110 in FIG. 1 (for a resizing or repositioning operation) or it corresponds to the communication 310 in FIG. 3. Lastly, at box 412, the parent application receives operating system responses to the modification command. These responses may comprise event notifications and the like.

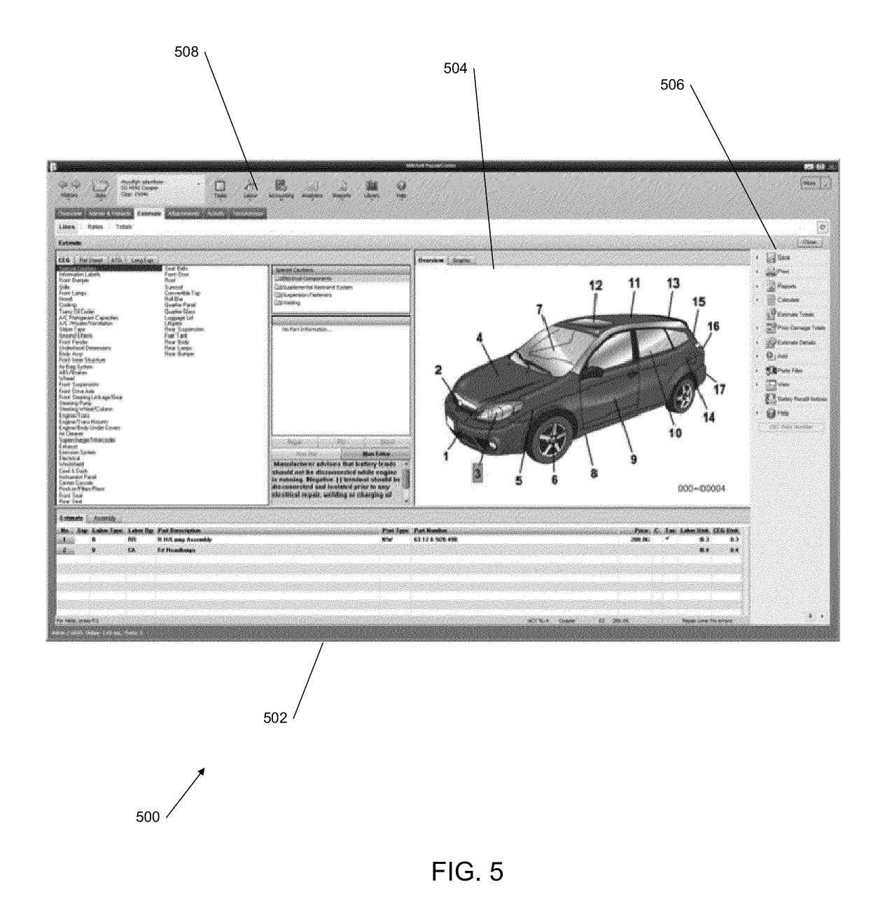

FIG. 5 shows a display screen 500 of a computer that is installed with a parent application and embedded child applications as described herein for a shop management parent application called “Mitchell RepairCenter”. The parent application is displayed in a window 502 that provides the functions of a legacy application that would otherwise comprise an embedded child application. A portion of the parent application window shows a program window portion 504 that comprises an embedded child application, a legacy application referred to as “Mitchell Estimating”, which is described further below. The parent application provides a menu bar 506 for selection of commands for the embedded child application Mitchell Estimating. FIG. 5 shows the menu bar for the child application with a vertical orientation, but the look and feel of the child application within the parent application window is freely selectable and specified by the parent application. Similarly, the parent application menu bar 508 is specified by the parent application and is shown in FIG. 5 with a horizontal orientation. Those skilled in the art will understand that the configuration of the display windows and the items to be displayed are at the discretion of the parent application developer.

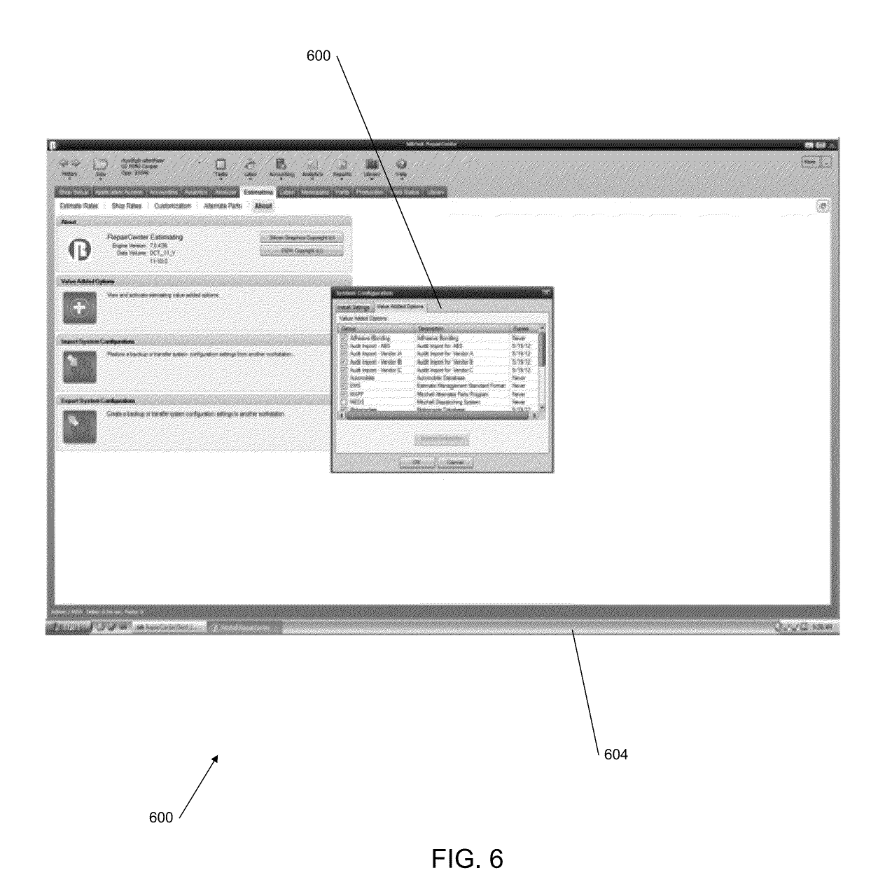

FIG. 6 shows a display screen 600 from the application illustrated in FIG. 5 with a System Configuration “Value Added Options” pop-up window 602 of the child application, as received while showing an “About” sub-tab of an “Estimating” tab of the parent application 604. To show the pop-up window 602 of the child application in the window of the parent application 604, the parent application receives a notification from the operating system of the pop-up window event in the child application, and the parent application contains program instructions that then cause the pop-up window 602 to be displayed as illustrated in FIG. 6.

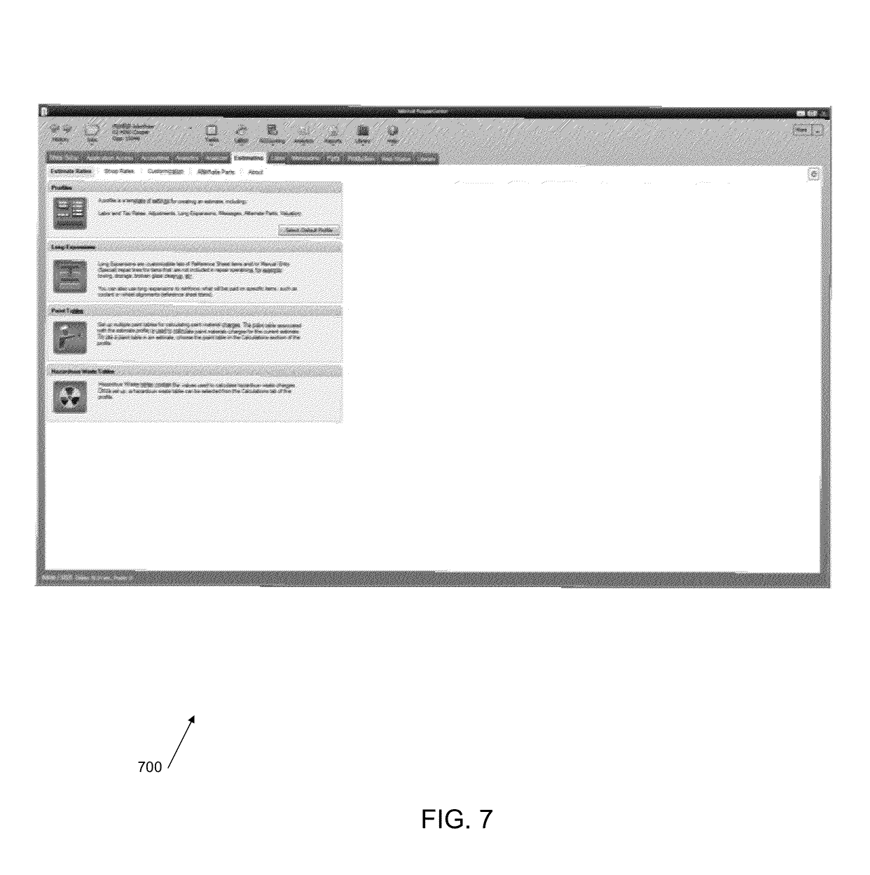

FIG. 7 shows a display screen 700 from the parent application illustrated in FIG. 5, with menu options available under the Estimating tab illustrated in FIG. 6.

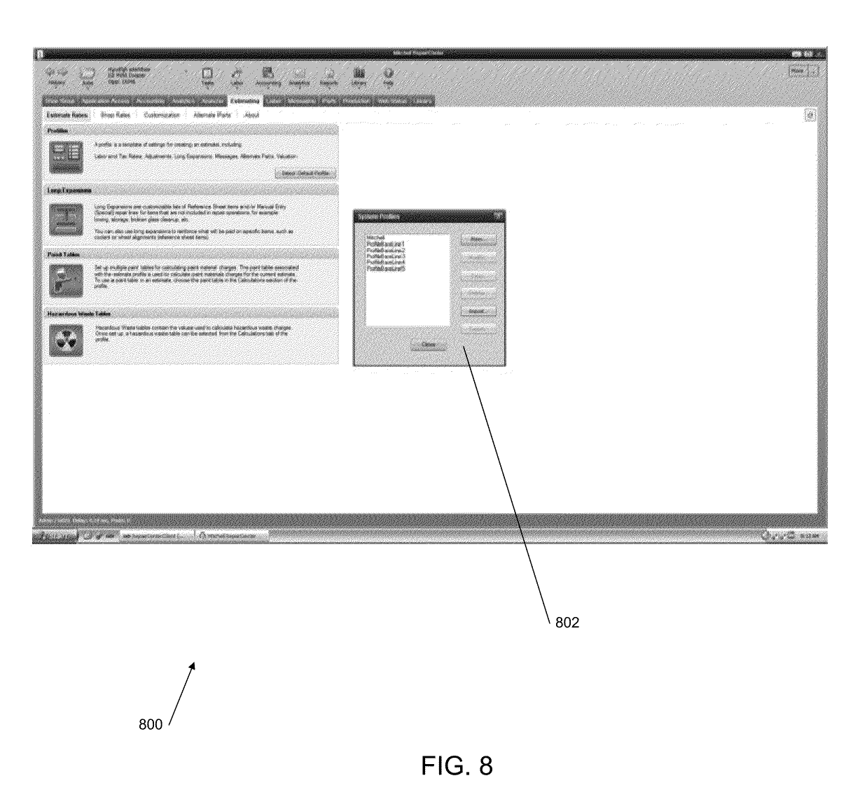

FIG. 8 shows a display screen 800 from the parent application illustrated in FIG. 5, with a “System Profiles” pop-up window 802 of the child application, as received while showing the “Estimating” tab of the parent application.

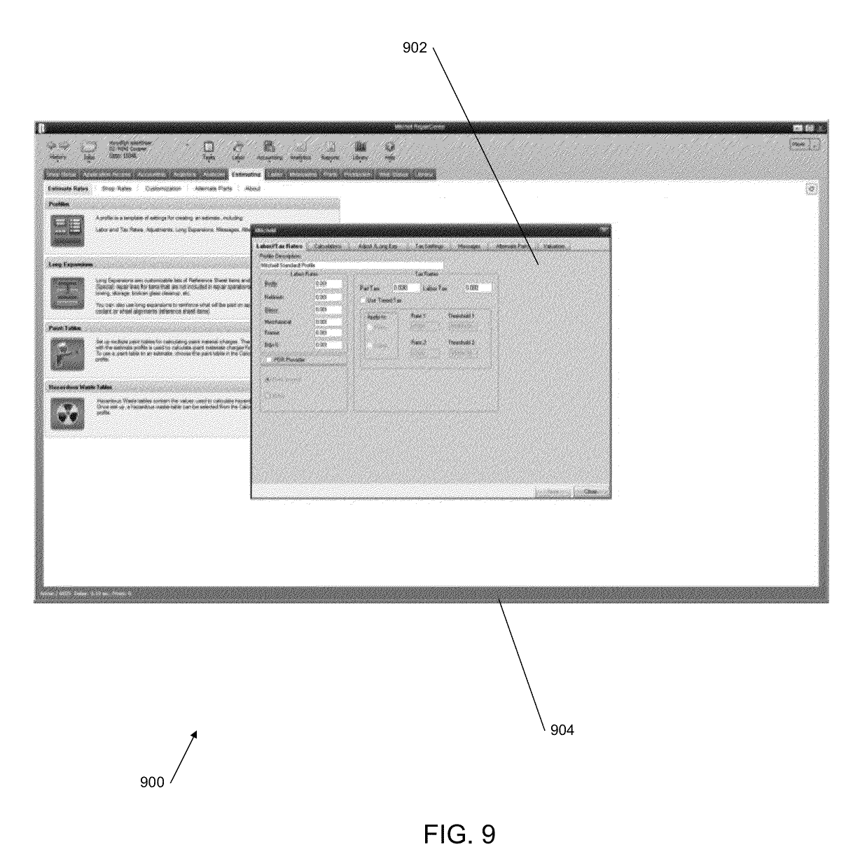

FIG. 9 shows a display screen 900 from the parent application illustrated in FIG. 5, with an “Estimate Rates” pop-up window 902 of the parent application while showing the “Estimating” tab in the parent application window 904. For the pop-up window 902, the data in the pop-up window contains data from the child application “Mitchell Estimating” that would otherwise appear in a pop-up window of the child application, but which is re-packaged by the parent application to provide a preferred display format in the parent application window. That is, the parent application may include program instructions so as to display information from the child applications, including notifications and events, in a desired manner, independently of the format that otherwise would be used for display of the information according to the child application.

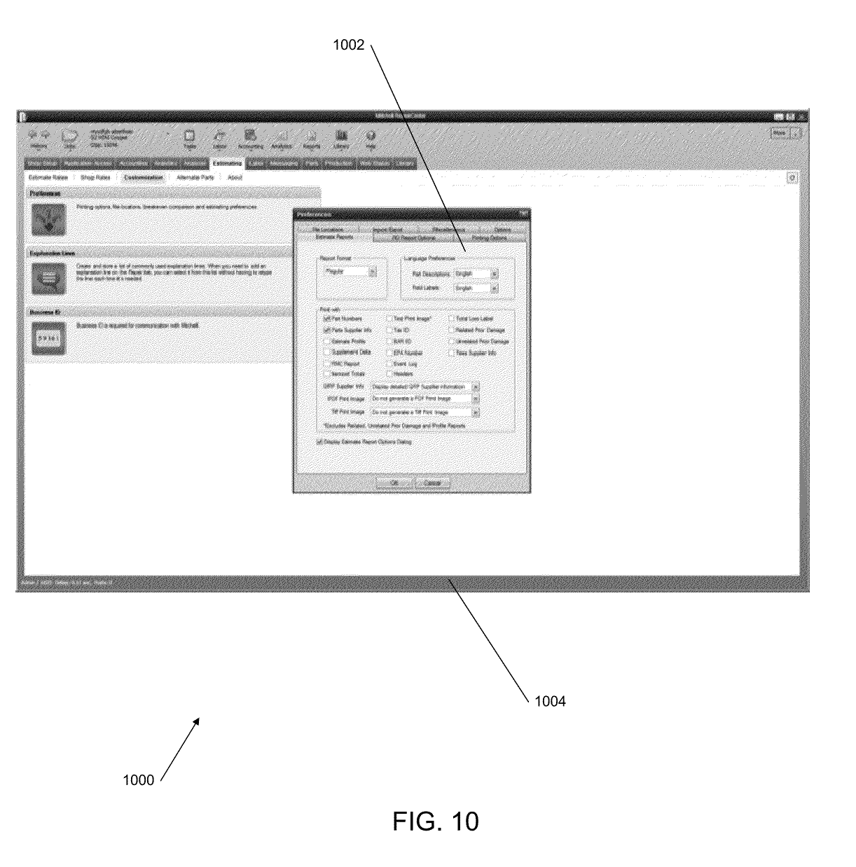

FIG. 10 shows a display screen 1000 from the parent application illustrated in FIG. 5, with a “Preferences” pop-up window 1002 of the child application illustrated in FIG. 5 while showing the “Estimating” tab of the parent application window 1004.

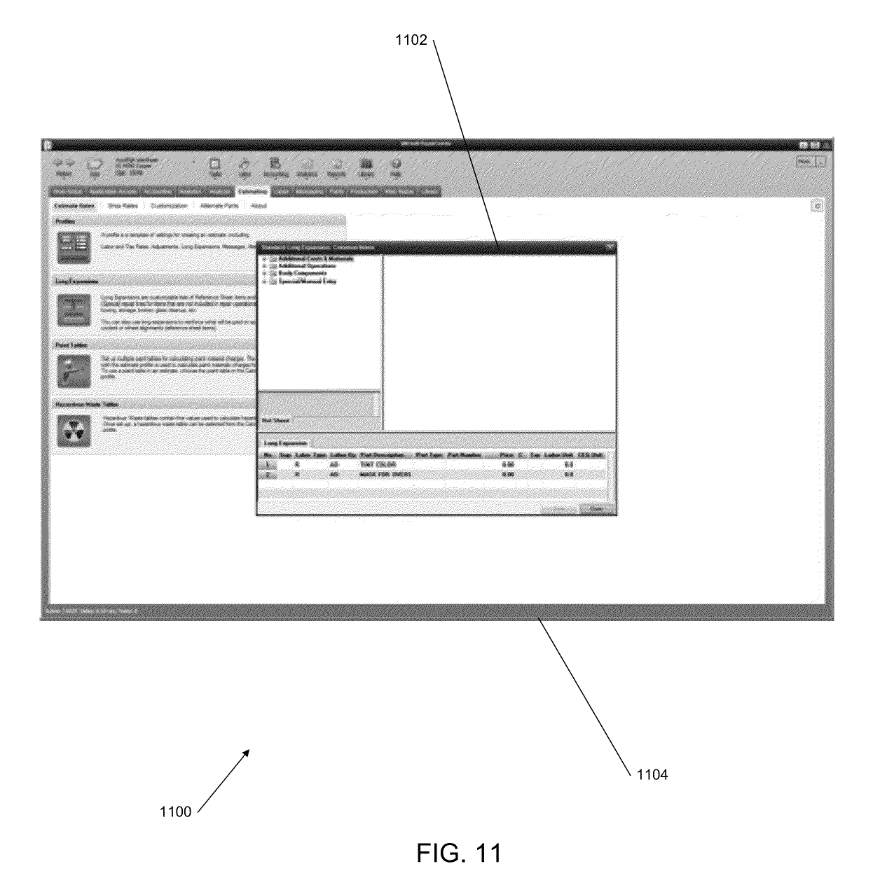

FIG. 11 shows a display screen 1100 from the parent application illustrated in FIG. 5, with a “Standard Long Expansion” pop-up window 1102, or dialog box, of the parent application while showing the “Estimating” tab in the parent application window 1104. As was the case with FIG. 9, the pop-up window 1102 contains data from a pop-up window of the child application, but which is re-packaged in a desired format in a pop-up window (dialog box) of the parent application.

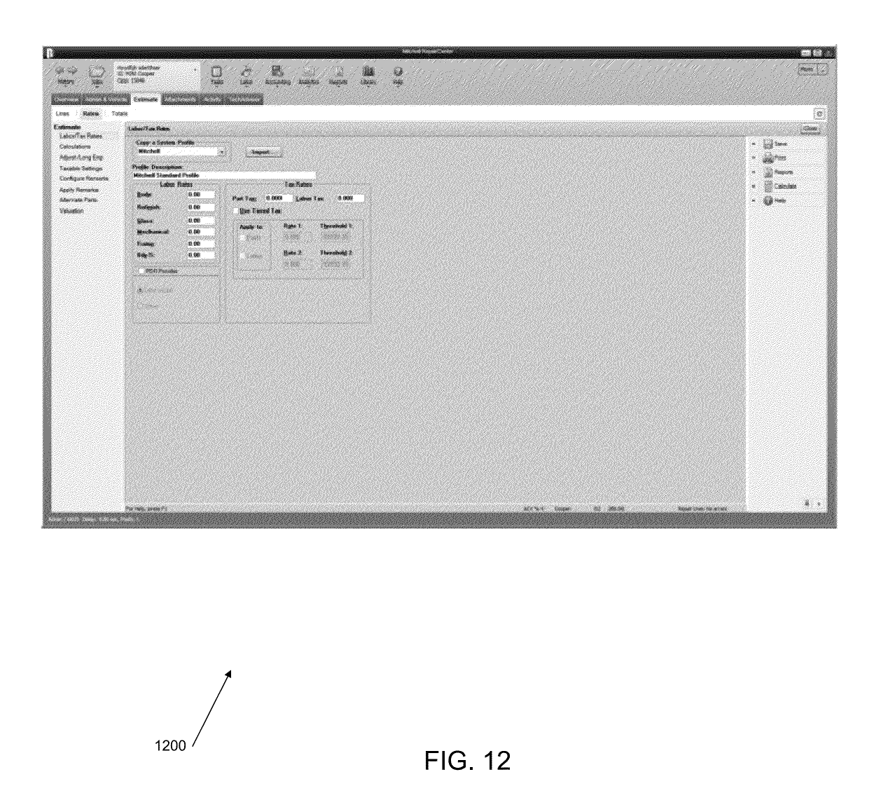

FIG. 12 shows a display screen 1200 with a “Labor/Tax Rates” window of the parent application illustrated in FIG. 5 under the “Estimate” tab.

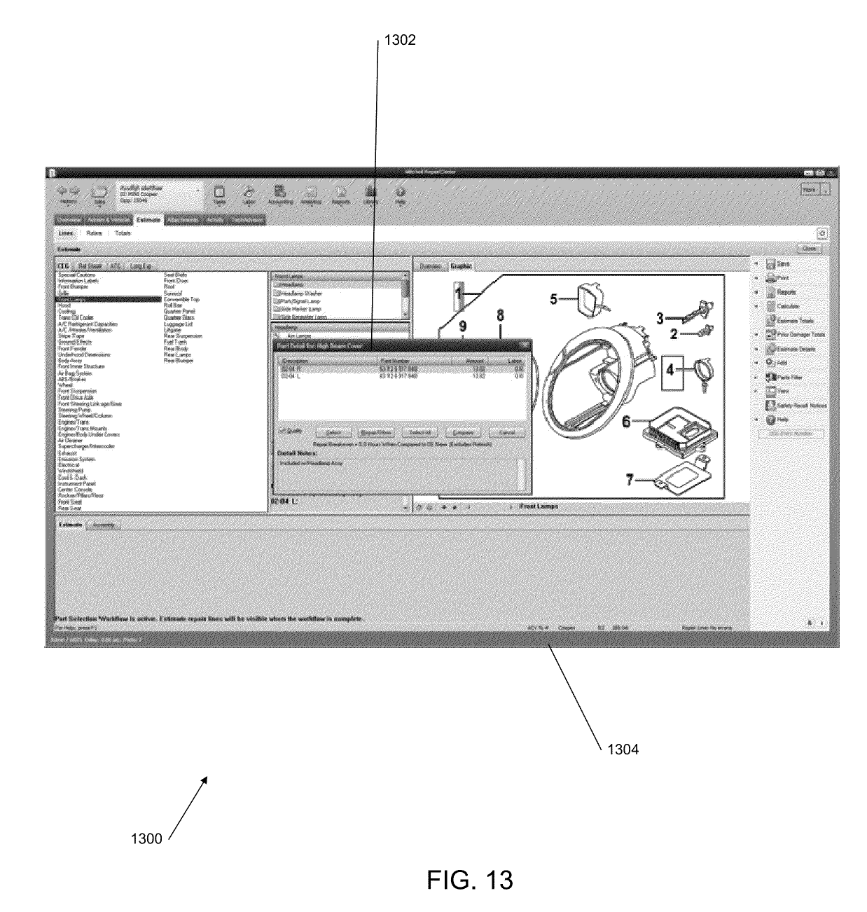

FIG. 13 shows a display screen 1300 from the parent application illustrated in FIG. 5, with a “Part Detail” pop-up window 1302 of the child application illustrated in FIG. 5 while showing the “Estimate” tab of the parent application window 1304. That is, the parent application contains program instructions so that the “Part Detail” pop-up window from the child application is displayed as a pop-up window of the parent application in a format that is largely intact from the corresponding child application pop-up window.

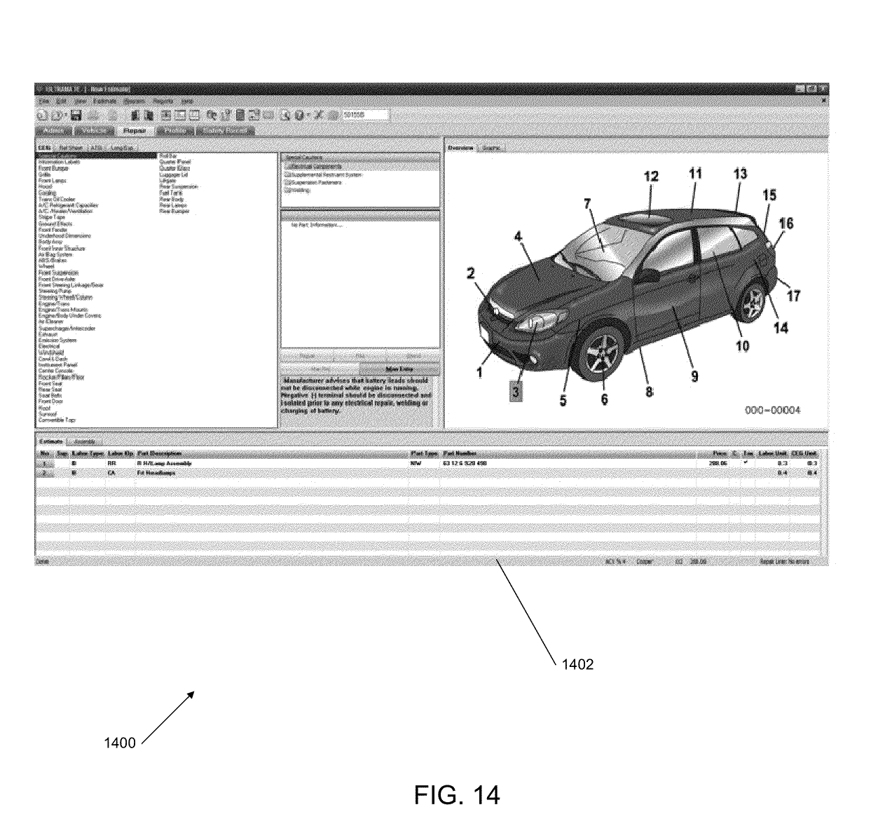

FIG. 14 shows a display screen 1400 with a display screen of the installed application called “Mitchell Estimating” that comprises an embedded child application as noted above. The Mitchell Estimating window 1402 is provided by the operating system when the child application is operated independently of the parent application called “Mitchell RepairCenter” as illustrated in FIG. 5.

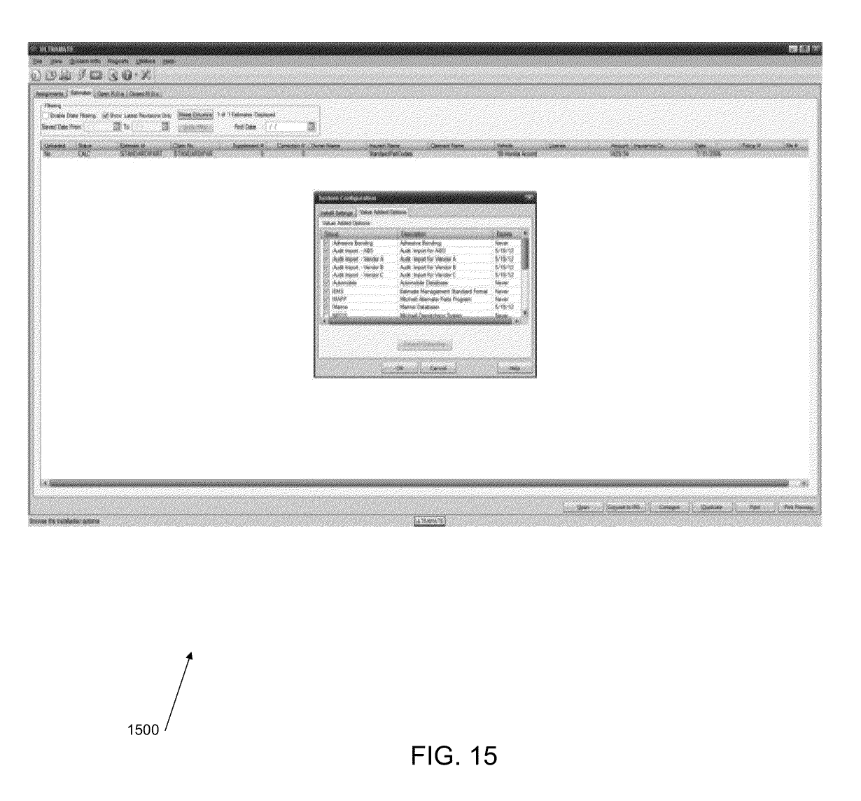

FIG. 15 shows a display screen 1500 with a “System Configuration” pop-up window of the “Mitchell Estimating” installed application illustrated in FIG. 14, corresponding to the information displayed in the “System Configuration” pop-up window illustrated in FIG. 6 of the parent application.

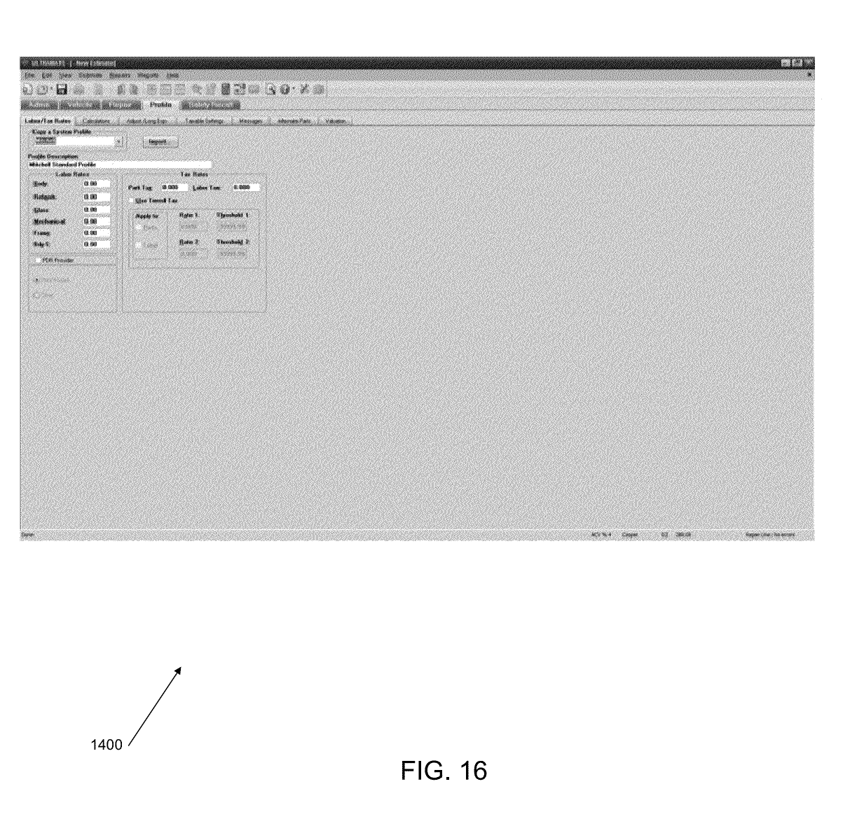

FIG. 16 shows a display screen 1600 with an “Estimate Rates” pop-up window of the

“Mitchell Estimating” installed application illustrated in FIG. 14, corresponding to the information displayed in the parent application pop-up window illustrated in FIG. 9.

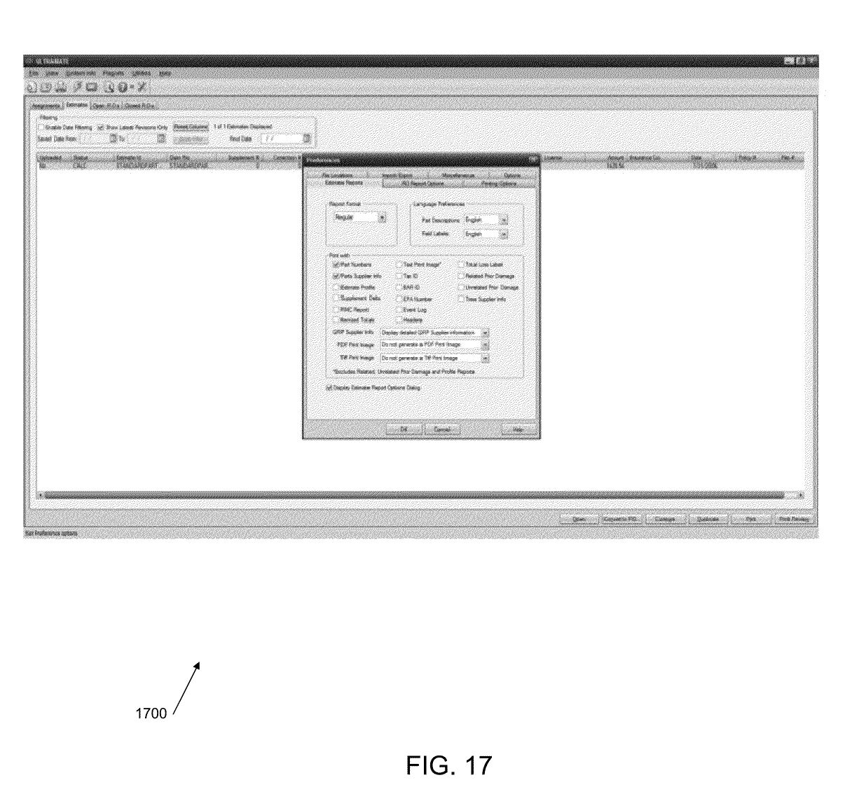

FIG. 17 shows a display screen 1700 with a “Preferences” pop-up window of the “Mitchell Estimating” installed application illustrated in FIG. 14, corresponding to the pop-up window of the parent application illustrated in FIG. 10.

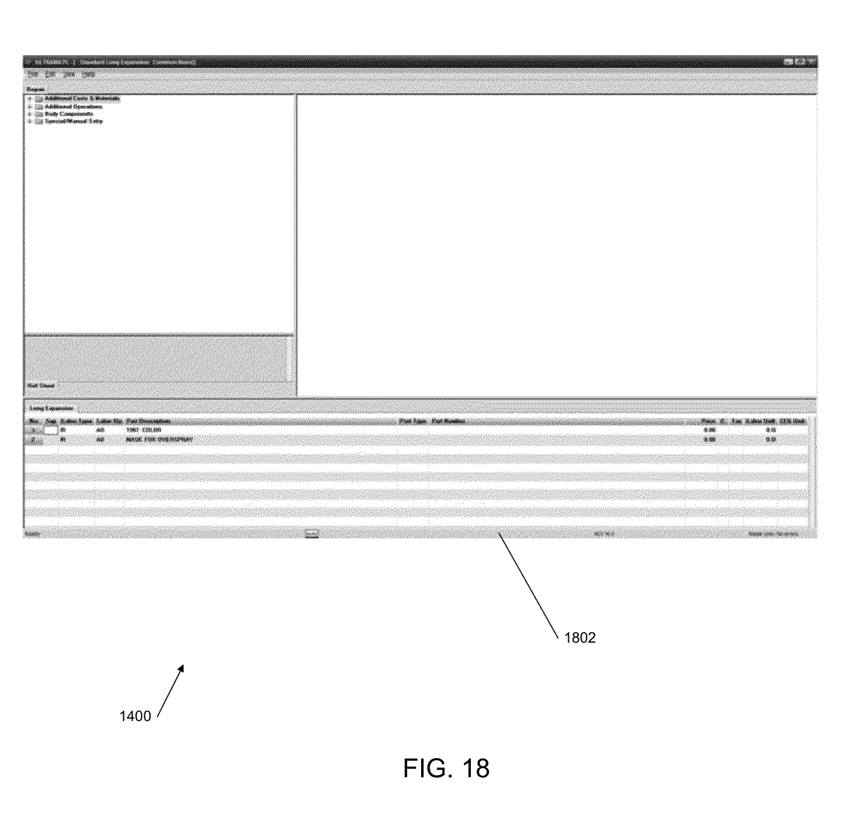

FIG. 18 shows a display screen 1800 with a “Standard Long Expansion” view window 1802 of the “Mitchell Estimating” installed application when operated independently of the parent application, showing the information that is re-packaged to the pop-up window of the parent application as illustrated in FIG. 11.

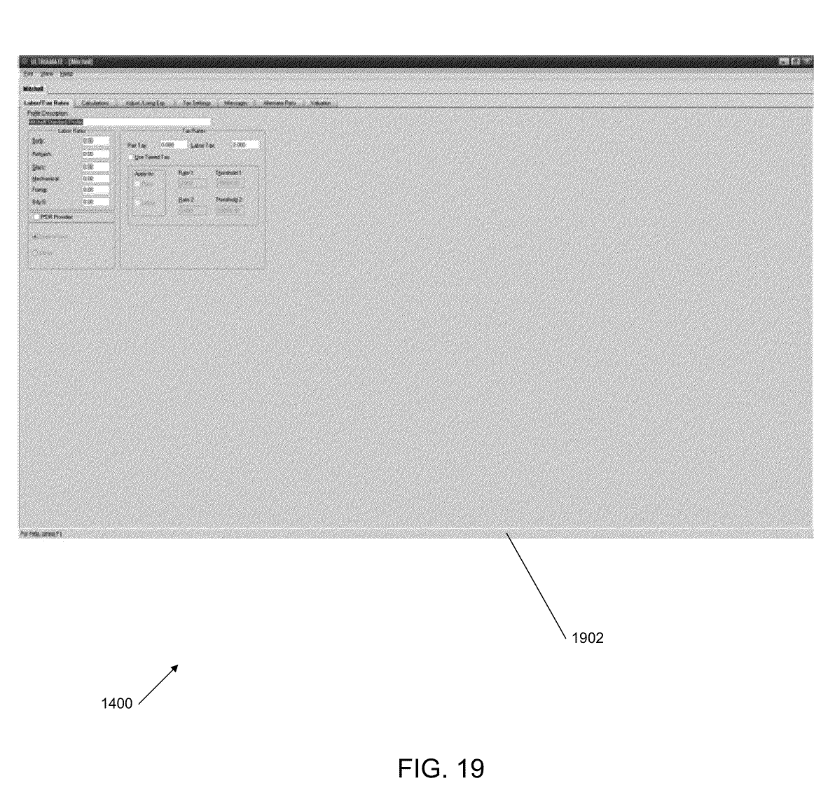

FIG. 19 shows a display screen 1900 with a “Labor/Tax Rates” view window 1902 of the “Mitchell Estimating” application when operated independently of the parent application, showing the information that is displayed as a view of the parent application as illustrated in FIG. 12.

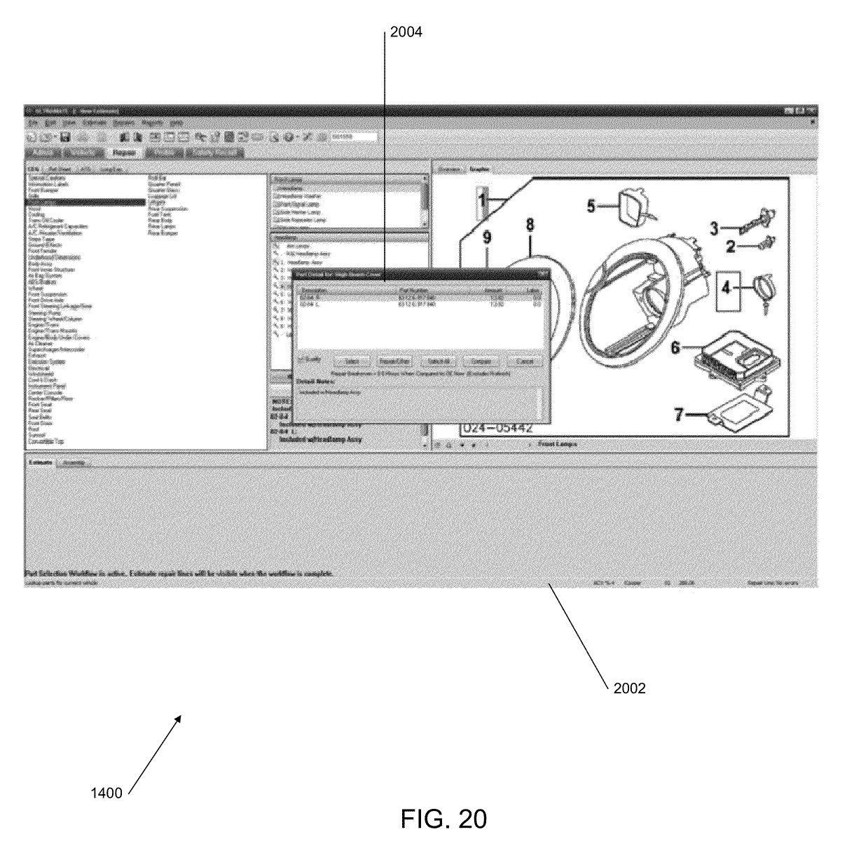

FIG. 20 shows a display screen 2000 with a view window 2002 of the “Mitchell Estimating” installed application showing a “Part Detail” pop-up window 2004 of the “Mitchell Estimating” application when operated independently of the parent application, showing the information that is displayed as a view of the parent application as illustrated in FIG. 13.

A variety of hardware configurations can be used for the computer systems described above. For example, conventional server and desktop computers can be used for the computer system 100 and 300. In the illustrated embodiment, the computer systems may operate any of a variety of windowing computer operating systems, such as “Windows 7” or “Linux” or the like, that provide a graphical user interface (GUI). Other details of construction and operation will occur to those skilled in the art in view of the description herein. Those skilled in the art will appreciate that a wide variety of operating systems can provide a suitable environment for execution of the operations described herein. Thus, any computer device that can perform the operations described herein can be utilized in a managed network system constructed in accordance with the invention.

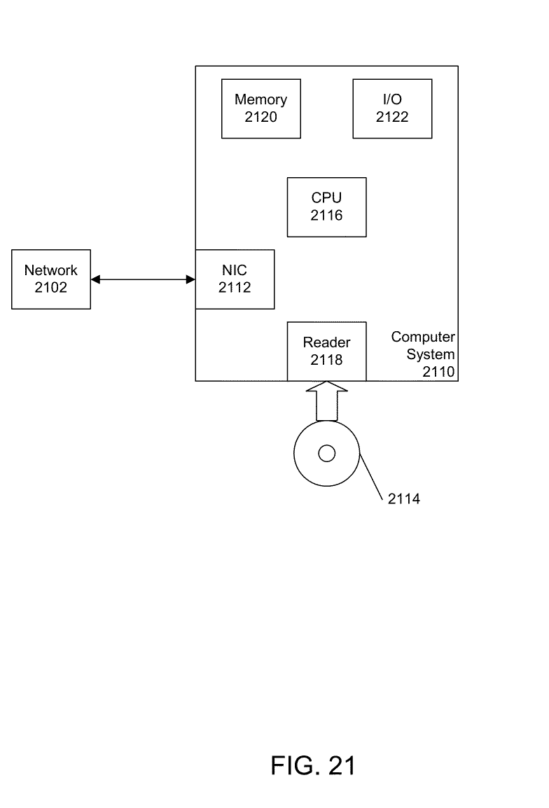

FIG. 21 shows a configuration for a computer system 2110 constructed in accordance with the present disclosure. The computer system 2110 can comprise a system such as a personal computer or server computer or the like. The computer system 2110 may include a network communication interface 2112 that permits communications with a network 2102. The network interface can comprise a network interface card (NIC). The computer system 2110 can execute instructions to provide an operating system that supports multiple installed application programs, including the operation of the parent application and embedded child applications as described herein.

The computer system 2110 includes a central processor unit 2116 (CPU) and a program product reader 2118 for receiving a program product media and reading program instructions recorded thereon. The computer system also includes associated memory 2120 and input/output facilities 2122, such as a display for output and a keyboard and/or mouse for input. The processor 2116 of the computer system 2110 can receive program instructions into the program memory of the processor. The program instructions can be received directly, such as by flashing EEPROM of the processor, or can be received through the network interface 2112, such as by download from a connected device or over a WAN or LAN network communication. If desired, the program instructions can be stored on a computer program product 2114 that is read by the computer system 2110 so that the program instructions can thereafter executed. That is, the program product 2114 is for use in a system such as the computer system 2110, wherein the program product comprises a tangible, non-transitory recordable media containing a program of computer-readable instructions that are executable by the device processor 2104 to perform the operations described herein. The program product 2114 can comprise, for example, optical program media such as CD or DVD data discs, or flash memory drives, or external memory stores, or floppy magnetic disks, and the like.

The present invention has been described above in terms of presently preferred embodiments so that an understanding of the present invention can be conveyed. There are, however, many configurations for network devices and management systems not specifically described herein but with which the present invention is applicable. The present invention should therefore not be seen as limited to the particular embodiments described herein, but rather, it should be understood that the present invention has wide applicability with respect to network devices and management systems generally. All modifications, variations, or equivalent arrangements and implementations that are within the scope of the attached claims should therefore be considered within the scope of the invention.

What is claimed is:

1. A computer system comprising:
a memory that stores program instructions and operating data;
a processor that executes the program instructions to provide an operating system with a user interface presented on a display of the computer system;
a plurality of computer applications installed in the computer system such that each computer application is operable as a program hosted by the operating system and is allocated its own respective memory space by the operating system and includes a library that is utilized for its operation, and such that the operating system designates only one of the computer applications as an active application at any time;
wherein one of the installed computer applications comprises a parent application and one or more of the remaining installed computer applications comprise embedded child applications of the parent application such that the parent application designates itself as the parent application to all the embedded child applications, and the parent application detects when one of the embedded child applications is not running and, in response, launches the not running embedded child application for operation, and wherein the parent application changes display attributes in the operating system of itself and the embedded child applications to ensure that the parent application and the embedded child applications are displayed as a single integrated application.

2. A computer system as in claim 1, wherein the parent application attribute that is changed comprises denoting that the parent application is parent to all child windows of the embedded child applications.

3. A computer system as in claim 1, wherein the parent application determines when any one of the embedded child applications is the active application of the operating system and, in response, the parent application attribute that is changed comprises indicating to the operating system that the parent application is to be illuminated.

4. A computer system as in claim 1, further including a unidirectional communication channel through which the parent application receives event notifications from the embedded child applications that notify the parent application of events in the respective embedded child applications.

5. A computer system as in claim 1, further including a bidirectional communication channel through which the parent application provides commands to the embedded child applications.

6. A computer system as in claim 1, wherein the parent application changes display attributes of itself and the embedded child applications in the operating system so that a modification to the display properties of any one of the parent application and embedded child applications is propagated to all of the parent application and embedded child applications.

7. A computer system as in claim 6, wherein the modification to the display properties comprises either a resizing or repositioning operation to an application window of one of the parent application or embedded child applications.

8. A method of operating a computer system, the method comprising:
receiving, at a parent application operating as a program hosted within an operating system of the computer, a command selected through a user interface on a display of the operating system by a user for modifying operation of a computer application selected from a plurality of computer applications installed in the computer system such that each installed computer application is operable as a program hosted by the operating system and is allocated its own respective memory space by the operating system and includes a library that is utilized for its operation, and such that the operating system designates only one of the installed computer applications as an active application at any time; and
forwarding the selected command from the parent application to the operating system such that the operating system forwards the selected command to the selected computer application to modify its operation;
wherein the selected computer application is one of one or more of the installed computer applications that comprise an embedded child application of the parent application such that the parent application designates itself as the parent application to all the embedded child applications, and the parent application detects when one of the embedded child applications is not running and, in response, launches the not running embedded child application for operation, and wherein the parent application changes display attributes in the operating system of itself and the embedded child applications to ensure that the parent application and the embedded child applications are displayed as a single integrated application.

9. A method as in claim 8, wherein the parent application attribute that is changed comprises denoting that the parent application is parent to all child windows of the embedded child applications.

10. A method as in claim 8, wherein the parent application determines when any one of the embedded child applications becomes the active application of the operating system and, in response, the parent application attribute that is changed comprises indicating to the operating system that the parent application is to be illuminated.

11. A method as in claim 8, further including a unidirectional communication channel through which the parent application receives event notifications from the embedded child applications that notify the parent application of events in the respective embedded child applications.

12. A method as in claim 8, further including a bidirectional communication channel through which the parent application provides commands to the embedded child applications.

13. A method as in claim 8, wherein the parent application changes display attributes of itself and the embedded child applications in the operating system so that a modification to the display properties of any one of the parent application and embedded child applications is propagated to all of the parent application and embedded child applications.

14. A method as in claim 13, wherein the modification to the display properties comprises either a resizing or repositioning operation to an application window of one of the parent application or embedded child applications.
